(19) United States
(12) Patent Application Publication
(10) Pub. No.: US 2008/0124298 A1
(43) Pub. Date: May 29, 2008

(54) Antifouling Coating Composition and Its Use on Man Made Structures

(75) Inventors: Trevor Solomon, Rowlands Gill (GB); John David Sinclair-Day, Ryton (GB); Alistair Andrew Finnie, Whitley Bay (GB)

Correspondence Address: KENYON & KENYON LLP, ONE BROADWAY, NEW YORK, NY, 10004, US

(73) Assignee: Akzo Nobel Coating International B.V., Arnhem (NL)

(21) Appl. No.: 10/585,917

(22) PCT Filed: Jan. 19, 2005
(86) PCT No.: PCT/EP05/00563

§ 371 Date: Sep. 21, 2007

Related U.S. Application Data
(60) Provisional application No. 60/543,281, filed on Feb. 11, 2004.

(30) Foreign Application Priority Data
Feb. 3, 2004 (EP) 04075343.6

(51) Int. Cl. A01P 15/00; A01N 25/10; A01N 59/20

(52) U.S. Cl. 424/78.09

(57) ABSTRACT

The invention pertains to an antifouling coating composition including
20-100% by weight, calculated on the total amount of film-forming components, of a film-forming polymer (A) having an acrylic backbone bearing at least one terminal group of the formula:

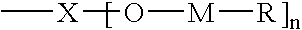

wherein X represents

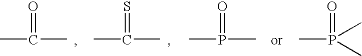

M is a metal of Group Ib, IIa, IIb, IIIa, IIIb, IVa, IVb, Va, VIa, VIb, VIIa, and VIII of the Periodic Table with a valency of 2 or more and a degree of ionisation less than that of the alkali metals metal; n is an integer of 1 to 2; R represents an organic residue selected from

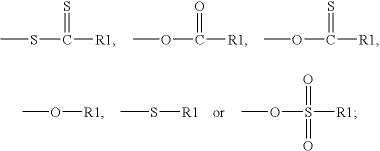

and R1 is a monovalent organic residue, and
80-0% by weight, calculated of polymer (B)
a copper-based biocide for aquatic organisms
   wherein the antifouling coating composition is substantially free of any biocidal zinc compounds and substantially free of rosin, and in that the copper-based biocide has a metallic copper content below 2% by weight, based on the total weight of the copper-based biocide.
The antifouling composition of the present invention combines a high storage stability with good performance under all aquatic conditions, irrespective of salinity.

This invention relates to an antifouling coating composition with good storage properties which is suited as coating on man-made structures immersed in an aquatic environment, irrespective of the salinity thereof.

Man-made structures such as boat hulls, buoys, drilling platforms, oil production rigs, and pipes which are immersed in water are prone to fouling by aquatic organisms such as green and brown algae, barnacles, mussels, and the like. Such structures are commonly of metal, but may also comprise other structural materials such as wood, fibre-lass or concrete. This fouling is a nuisance on boat hulls, because it increases frictional resistance during movement through the water, the consequence being reduced speeds and increased fuel costs. It is a nuisance on static structures such as the legs of drilling platforms and oil production rigs, firstly because the resistance of thick layers of fouling to waves and currents can cause unpredictable and potentially dangerous stresses in the structure, and, secondly, because fouling makes it difficult to inspect the structure for defects such as stress cracking and corrosion. It is a nuisance in pipes such as cooling water intakes and outlets, because the effective cross-sectional area is reduced by fouling, with the consequence that flow rates are reduced. An antifouling coating composition will generally be applied as a top-coat on immersed areas of the structure to inhibit the settlement and growth of aquatic organisms such as barnacles and algae, generally by the release of a biocide for the aquatic organisms.

Traditionally, antifouling coating compositions have comprised a relatively inert binder with a biocidal pigment that is leached from the coating composition. Among the binders which have been used are vinyl resins and rosin or rosin derivatives. Vinyl resins are water-insoluble and coating compositions based on them use a high pigment concentration so as to have contact between the pigment particles to ensure leaching. Rosin is a hard brittle resin that is very slightly soluble in water. Rosin-based antifouling coating compositions have been referred to as soluble matrix or eroding coating compositions. The biocidal pigment is very gradually leached out of the matrix of rosin binder in use, leaving a skeletal matrix of rosin, which becomes washed off the hull surface to allow leaching of the biocidal pigment from deep within the coating composition film.

Many successful antifouling coating compositions in recent years have been “self-polishing copolymer” coating compositions based on a polymeric binder to which biocidal tri-organotin moieties are chemically bound and from which the biocidal moieties are gradually hydrolysed in an aquatic environment. In such binder systems, the side groups of a linear polymer unit are split off in a first step by reaction in the aqueous medium, the polymer framework that remains becoming water-soluble or water-dispersible as a result. In a second step, the water-soluble or water-dispersible framework at the surface of the coating composition layer on the ship is washed out or eroded. Such coating composition systems are described for example in GB-A-1 457 590.

As the use of tri-organotin has been prohibited world-wide, there is a need for alternative antifouling substances that can be used in antifouling compositions. Self-polishing copolymer coating compositions, which release non-biocidal moieties, are described in EP-A-69 559, EP-A-529 693, WO-A-91/14743, WO-A-91/09915, GB-A-231 070, and JP-A-9-286933.

Very promising self-polishing copolymer coating compositions which release non-biocidal moieties are disclosed for example in EP-A-204 456 and EP-A-779 304. The binder used in the coating compositions comprises an acrylic backbone bearing at least one terminal group of the formula:

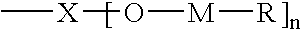

wherein X represents

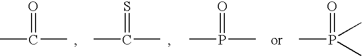

M is a metal selected from, e.g., zinc, copper and tellurium; n is an integer of 1 to 2; R represents an organic residue selected from

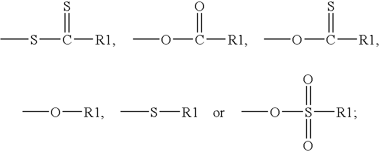

and

R1 is a monovalent organic residue.

Usually the binder is mixed with a biocide for aquatic organisms.

Commercially successful antifouling coating compositions of this type most commonly comprise a binder in which X is

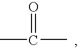

### M is copper, R represents

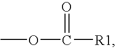

and the binder is mixed with cuprous oxide and a biocidal zinc compound such as zinc pyrithione.

More recently, antifouling coating compositions have been developed where the binder comprises a rosin material and an auxiliary film-forming resin, the auxiliary film-forming resin comprising an acid-functional film forming polymer whose acid groups are blocked by groups capable of hydrolyzing, dissociating or exchanging with seawater species to leave a polymer soluble in seawater, and optionally a portion of a non-hydrolyzing water-insoluble film-forming polymer. Such coating compositions are described in WO 02102698.

However, even though antifouling coating compositions with acceptable properties are known in the art, there is still a need for products with improved properties.

In the first place, it has been found that there is need for a coating composition with an increased long term storage-stability in the liquid state (shelf life).

Additionally, there is need for an antifouling coating composition which can perform well in all aqueous environments, irrespective of salinity. This will be elucidated below.

It is common practice in the marine construction industry for ships and other man-made objects to be fabricated on land or in a floating dry-dock and then launched or floated out after completion of the main structure. Fabrication of the ship or other man-made object may then be completed and the structure fitted-out while it is immersed in an aquatic environment. In many countries, for example in Europe, such as Romania, or in China, ships and other man-made objects are often launched into a low salinity or fresh water aquatic environment such as the Baltic Sea, or a river or river estuary. Many such structures will then subsequently encounter an ocean water or other aquatic environment with a higher salinity during its normal operation. In some cases, the structure will encounter changes in the salinity of the aquatic environment, for example when a ship regularly travels between a river or river estuary and the ocean.

It has been found that antifouling coating compositions which perform well in ocean water or a high salinity aquatic environment do not necessarily perform well, and may even perform very poorly, in a fresh water or low salinity aquatic environment.

For example, the commercially successful antifouling coating compositions discussed above, which comprise a binder in which X is —C═O, M is copper, R represents —COO—R1, in combination with cuprous oxide and a biocidal zinc compound such as zinc pyrithione generally have excellent and durable physical and mechanical properties when immersed in a salt water or brackish aquatic environment but it was found that they exhibit excessive softening, cracking, blistering or delamination upon exposure in a fresh water or low salinity aquatic environment.

For another example, the rosin-based antifouling coating compositions described in WO 02/02698 have poorer physical and mechanical properties upon immersion in a fresh water or low salinity aquatic environment than in an ocean water or high salinity aquatic environment. Additionally, rosin-based coating compositions generally show less persistent antifouling performance than rosin-free self polishing antifouling coating compositions.

Surprisingly it was found that an antifouling coating composition which combines a good long term storage-stability in the liquid state (shelf life) with the ability to perform well in all aqueous environments, irrespective of salinity, can be achieved by selecting a specific biocide with a specific metallic metal content, wherein the composition should be substantially free of biocidal zinc compounds and rosin.

Accordingly, the present invention pertains to an antifouling coating composition comprising
20-100% by weight, calculated on the total amount of film-forming components, of a film-forming polymer (A) having an acrylic backbone bearing at least one terminal group of the formula:

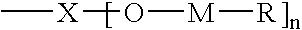

wherein X represents

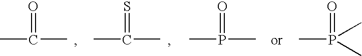

M is a metal of Group Ib, IIa, IIb, IIIa, IIIb, IVa, IVb, Va, VIa, VIb, VIIa, and VIII of the Periodic Table with a valency of 2 or more and a degree of ionisation less than that of the alkali metals metal; n is an integer of 1 to 2; R represents an organic residue selected from

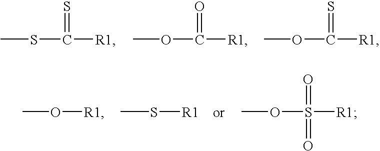

and R1 is a monovalent organic residue, and
80-0% by weight, calculated on the total amount of film-forming components, of polymer (B) selected from polymers which are free of -X-[O-M-R]ₙ terminal groups and which is reactive in water, slightly water-soluble or water-sensitive, or insoluble in water
a copper-based biocide for aquatic organisms
   characterised in that that the antifouling coating composition is substantially free of any biocidal zinc compounds and substantially free of rosin, and in that the copper-based biocide has a metallic copper content below 2% by weight, based on the total weight of the copper-based biocide.

M is a metal of Group Ib, IIa, IIb, IIIa, IIIb, IVa, IVb, Va, VIa, VIb, VIIa, and VIII of the Periodic Table with a valency of 2 or more and a degree of ionisation less than that of the alkali metals metal. The use of one or more of Ca, Mg, Zn, Cu, Te, Ba, Pb, Fe, Co, Ni, Si, Ti, Mn, Al, Bi, and Sn is preferred. The use of one or more of Cu, Zn, and Te is more preferred, with the use of one or more of Cu and Zn being even more preferred, and the use of Cu being particularly preferred.

Preferably, the film-forming polymer (A) is an acrylic polymer in which X represents

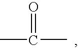

### M is copper and R represents

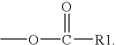

The parent acrylic polymer having a -COOH group in place of -X-[O-M-R]ₓ preferably has an acid value of 25-350 mg KOH/g. Such hydrolysable polymers can be prepared by the processes of EP-A-204456 and EP-A-342276. Most preferably the hydrolysable polymer has a copper content of 0.3-20% by weight. The copper-containing film-forming polymer (A) is preferably a copolymer comprising an acrylic or methacrylic ester whose alcohol residue includes a bulky hydrocarbon radical or a soft segment, for example a branched alkyl ester having 4 or more carbon atoms or a cycloalkyl ester having 6 or more atoms, a polyalkylene glycol monoacrylate or monomethacrylate optionally having a terminal alkyl ether group or an adduct of 2-hydroxyethyl acrylate or methacrylate with caprolactone, as described in EP-A-779304.

It is preferred for R to be the residue of an organic monobasic carboxylic acid which has a boiling point greater than 115° C. and an acid value between 50 and 950 mgKOH/gramme. There is no particular upper limit on the boiling point and R may be the residue of a substantially non-volatile acid. The material will generally have a boiling or decomposition temperature below 500° C. The organic monobasic carboxylic acid may be referred to as a high-boiling acid. The acid may be aliphatic, aromatic, linear, branched, alicyclic or heterocyclic. It is particularly preferred for R to be the residue of one or more of the following acids: benzoic acid, salicylic acid, 3,5-dichlorobenzoic acid, lauric acid, stearic acid, nitro-benzoic acid, linoleic acid, ricinoleic acid, 12-hydroxy stearic acid, fluoroacetic acid, pulvic acid, ,O-cresotinic acid, naphthol-1-caboxylic acid, p-oxy-benzoic acid, chloroacetic acid, dichloroacetic acid, naphthenic acid, p-phenyl benzoic acid, lithocholic acid, phenoxy acetic acid, 2,4- dichlorophenoxy acetic acid, oleic acid, versatic acid, nicotinic acid, penicillic acid and the like, or a diterpenoid acid having an abietane, pimarane, isopimarane or labdane skeleton such as, for example, abietic acid, neoabietic acid, levopimaric acid, dextropimaric acid, sandaracopimaric acid, and the like which may be used individually or in combination.

The film-forming polymer (A) is generally present in the coating composition in an amount of at least 3 wt. %, preferably at least 6 wt. %, more preferably at least 10 wt. %. It is generally present in an amount of at most 60 wt. %, preferably at most 50 wt. %, more preferably at most 45 wt. %.

The film-forming polymer (A) can be a so-called high solids resin. By using such resin, a coating composition can be obtained with a volatile organic compound (VOC) content of not more than 400 g/L, preferably of less than 350 g/L.

The film-forming polymer (A) can be prepared as follows:
i) polymerization of an unsaturated organic acid monomer and an additional unsaturated monomer and either reacting the resulting acrylic resin with a metal compound and a monobasic acid or reacting said acrylic resin with a metal salt of a monobasic acid or
ii) reacting an unsaturated organic acid monomer with a metal compound and a monobasic acid or reacting an unsaturated organic acid monomer with a metal salt of a monobasic acid and polymerizing the resulting metal-containing unsaturated monomer with another unsaturated monomer.

In view of the higher yield method i) is preferred.

The unsaturated organic acid monomer mentioned above can be selected from the group of unsaturated compounds having at least one carboxyl group, for example unsaturated monobasic acids such as (meth) acrylic acid; unsaturated dibasic acids and monoalkyl esters thereof, such as maleic acid inclusive of its monoalkyl esters and itaconic acid inclusive of its monoalkyl esters; unsaturated monobasic acid hydroxyalkyl ester-dibasic acid adducts, such as 2-hydroxyethyl (meth)acrylate-maleic acid adduct, 2-hydroxyethyl (meth)acrylate-phthalic acid adduct, and 2-hydroxyethyl (meth)acrylate-succinic acid adduct. In this specification, the term (meth)acrylic acid is used to mean whichever of methacrylic acid and acrylic acid.

The additional unsaturated monomer can be selected from various esters of (meth)acrylic acid, e.g. alkyl (meth)acrylates, the ester moieties of which contain 1 to 20 carbon atoms, such as methyl (meth)acrylate, ethyl (meth)acrylate, i-propyl (meth)acrylate, n-butyl (meth)acrylate, i-butyl (meth)acrylate, t-butyl (meth)acrylate, 2-ethylhexyl (meth)acrylate, lauryl (meth)acrylate and stearyl (meth)acrylate; hydroxy-containing alkyl (meth)acrylates, the ester moieties of which contain 1-20 carbon atoms, such as 2-hydroxypropyl (meth)arylate and 2-hydroxyethyl (meth)acrylate; cyclic hydrocarbon esters of (meth)acrylic acid, such as phenyl (meth)acrylate and cyclohexyl (meth)acrylate; polyalkylene glycol esters of (meth)acrylic acid, such as polyethylene glycol mono (meth) acrylate and polyethylene glycol mono (meth) acrylate with a degree of polymerization in the range of 2 to 50; C₁₋₃ alkoxyalkyl (meth)acrylate; (meth)acrylamide; vinyl compounds such as styrene, alpha -methylstyrene, vinyl acetate, vinyl propionate, vinyl benzoate, vinyltoluene and acrylonitrile; esters of crotonic acid; and diesters of unsaturated dibasic acids, such as maleic acid diesters and itaconic acid diesters. Of the above-mentioned esters of (meth)acrylic acid, the ester moieties are preferably alkyl groups containing 1 to 8 carbon atoms, more preferably an alkyl groups containing 1 to 6 carbon atoms. The preferred specific compounds are methyl (meth)acrylate, ethyl (meth)acrylate, butyl (meth)acrylate and cyclohexyl (meth)acrylate.

The above-mentioned unsaturated organic acid monomers and other unsaturated monomers may each be used alone or in a mixture of two or more species.

The film-forming polymer (A) preferably has an acid value of 25 to 350 mg KOH/g. If the acid value is below 25 mg KOH/g, the amount of metal salt to be attached to the side chain is too low for effective antifouling and self-polishing properties. If it is above 350 mg KOH/g, the hydrolysis rate will be too high so that the service life of the antifouling coating is strongly reduced. In addition, such high acid value will result in a rise of the viscosity of the film-forming polymer (A), which would make it less suited for use in low VOC coatings. An acid value in the range from 100 to 250 mg KOH/g is preferred.

The antifouling coating comprises a copper-based biocide for aquatic organisms having a metallic copper content below 2% by weight, based on the total weight of the copper-based biocide. Preferably, the metallic copper content is below 1 percent by weight, more preferably below 0.8 percent by weight, and even more preferably below 0.7 percent by weight. If the copper-based biocide has a metallic copper content of more than 2 wt. %, the object of the present invention is not achieved.

The copper-based biocide for aquatic organisms with the low metallic copper content is generally present in an amount of at least 1 wt. %, preferably at least 5 wt. %, more preferably at least 10 wt. %, still more preferably at least 25 wt. %, based upon the total weight of the coating composition. The copper-based biocide is generally present in an amount of at most 75 wt. %, preferably at most 70 wt. %, still more preferably at most 60 wt. %, based upon the total weight of the coating composition.

Examples of such copper-based biocide for aquatic organisms include cuprous oxide, cuprous thiocyanate, cuprous sulphate, or copper pyrithione. These copper-based biocides can be used alone or in a mixture of two or more of these compounds.

In view of the good overall physical and antifouling properties, cuprous oxide with a low metal content is the preferred copper-based biocide for use in the antifouling coating composition according to the present invention. Since cupric oxide is often present as an impurity in cuprous oxide, the coating composition may contain an amount of cupric oxide of up to 10 percent by weight, preferably up to 6 percent by weight, more preferably up to 3 percent by weight, based on the total weight of cuprous oxide.

In a further preferred embodiment, the antifouling coating composition according to the present invention comprises a mixture of cuprous oxide having a metallic copper content below 2% by weight and copper pyrithione. In this case, cuprous oxide is preferably present in an amount of 20-60 wt. %, and copper pyrithione is preferably present in an amount of 1-15 wt. %.

As indicated above, the coating composition of the present invention is substantially free of biocidal zinc compounds and substantially free of rosin. If this requirement is not met, the advantageous effects of the present invention are not obtained. In the context of the present invention the indication substantially free of means that the component in question is not present in such an amount that the properties of the coating composition are detrimentally affected.

For the present application this means that the coating composition comprises less than 1 wt. % of rosin and less than 1 wt. % of biocidal zinc compounds, more preferred the coating composition comprises less than 0.1 wt. % of rosin and less than 0.1 wt. % of biocidal zinc compounds, the wt. % being calculated based upon the total content of the coating composition.

Within the framework of the present application, a biocidal zinc compound is a zinc compound that is used in an antifouling coating composition to provide a biocidal effect on aquatic fouling organisms. A Zn-containing polymer (A) is not a biocidal Zn compound within the framework of the present invention. For good order's sake it is noted that in the context of the present specification the wording free of rosin means free of free rosin, that is, free of rosin not bound to polymer (A) or polymer (B). The presence of free rosin leads to a reduction in the performance of the antifouling coating compositions.

The coating composition preferably has a pigment volume concentration of, for example, 15 to 55%, defined as the ratio, expressed as a percentage, of the total volume of pigments and/or extenders and/or other solid particles in a product to the total volume of the non-volatile matter.

In addition to the copper-based biocide for aquatic organisms having a metallic copper content below 2% by weight, the antifouling coating compositions according to the present application optionally comprise an additional ingredient having biocidal properties for aquatic organisms.

Further, the antifouling coating compositions may comprise one or more non-biocidal pigments, and/or additives such as one or more thickening or thixotropic agents, one or more wetting agents, plasticisers, fillers, a liquid carrier such as an organic solvent, organic non-solvent or water, etc., all as conventional in the art.

In addition to the film-forming polymer (A), the anti-fouling coating compositions according to the present invention optionally comprise another film-forming polymer (B). Polymer (B), which is present in an amount of 80-0% by weight, calculated on the total amount of film-forming components, is selected from polymers which are free of -X-[O-M-R]n terminal groups but which are reactive in water, slightly water-soluble, water-sensitive, or insoluble in water. It may be preferred for polymer (B) to be is selected from non-hydrolyzing water-insoluble film-forming polymers.

As examples of a suitable polymer (B) that is free of -X-[-O-M-R]ₙ terminal groups but which are reactive in water, several resins can be mentioned. For instance, an example of a suitable polymer is an acid-functional film-forming polymer, the acid groups of which are blocked by quaternary ammonium groups or quaternary phosphonium groups. This is for instance described in WO 02/02698.

A water-reactive polymer can alternatively be a film-forming polymer comprising quaternary ammonium groups and/or quaternary phosphonium groups bound (pendant) to the backbone of the polymer. These quaternary ammonium groups and/or quaternary phosphonium groups are neutralised or, in other words, blocked or capped by counter-ions. Said counter-ions consist of the anionic residue of an acid having an aliphatic, aromatic, or alkaryl hydrocarbon group comprising at least 6 carbon atoms. Such systems are for instance described in PCT/EP01/007693.

A further example of a suitable water-reactive polymer is a silyl ester copolymer comprising at least one side chain bearing at least one terminal group of the formula (I):

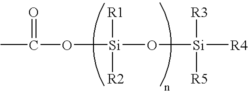

wherein n is 0 or an integer of 1 to 50, and R1, R2, R3, R4, and R5 are each independently selected from the group consisting of optionally substituted C₁₋₁₂₀-alkyl, optionally substituted C₁₋₂₀-alkoxy, optionally substituted aryl, and optionally substituted aryloxy.

Preferably, at least one of the groups R1-R5 in the silyl ester copolymer is methyl, isopropyl, n-butyl, isobutyl, or phenyl. More preferably, n is 0 and R3, R4, and R5 are the same or different and represent isopropyl, n-butyl, or isobutyl.

A silyl ester copolymer comprising at least one side chain bearing at least one terminal group of the above-described formula (I) can, for example, be obtained by copolymerising one or more vinyl polymerisable monomers with one or more monomers comprising one or more olefinic double bonds and one or more of the above-described terminal groups (I).

Examples of suitable vinyl polymerisable monomers, which can be copolymerised with one or more monomers comprising one or more olefinic double bonds and one or more of the above-described terminal groups (I), include (meth)acrylate esters such as methyl methacrylate, ethyl methacrylate, butyl methacrylate, 2-ethylhexyl methacrylate, 2-hydroxyethyl methacrylate, and methoxyethyl methacrylate; maleic acid esters such as dimethyl maleate and diethyl maleate; fumaric acid esters such as dimethyl fumarate and diethyl fumarate; styrene, vinyl toluene, α-methyl-styrene, vinyl chloride, vinyl acetate, butadiene, acrylamide, acrylonitrile, (meth)acrylic acid, acrylic acid, isobornyl methacrylate, maleic acid, and mixtures thereof. Preferably, a mixture of methyl (meth)acrylate or ethyl (meth)acrylate with another vinyl polymerisable monomer is used. It is possible to adjust the polishing rate of the coating by using a mixture of a hydrophobic and a hydrophilic (meth)acrylate. Optionally a hydrophylic comonomer is included such as methoxy ethyl (meth)acrylate or a higher polyethylene oxide derivative, such as ethoxy ethyl (meth)acrylate, propoxy ethyl (meth)acrylate, butoxy ethyl (meth)acrylate, a polyoxyethylene glycol monoalkyl ether (meth)acrylate, such as polyoxyethylene (n=8) glycol monomethyl ether methacrylate, or N-vinyl pyrrolidone.

Examples of suitable monomers comprising one or more olefinic double bonds and one or more of the above-described terminal groups (I), which can be copolymerised with one or more vinyl polymerisable monomers, include monomers comprising one or more of the terminal groups (I) in which n=0, and which may be represented by the formula (II):

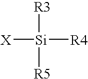

wherein R3, R4, and R5 are as defined above, and X is a (meth)acryloyloxy group, a maleinoyloxy group, or a fumaroyloxy group.

The preparation of the monomers (II) can, for example, be performed according to the methods described in EP 0 297 505, or according to the methods described in EP 1 273 589 and the references cited therein. Examples of suitable (meth)acrylic acid-derived monomers include: trimethylsilyl (meth)acrylate, triethylsilyl (meth)acrylate, tri-n-propylsilyl (meth)acrylate, triisopropylsilyl (meth)acrylate, tri-n-butylsilyl (meth)acrylate, triisobutylsilyl (meth)acrylate, tri-tert-butylsilyl (meth)acrylate, tri-n-amylsilyl (meth)acrylate, tri-n-hexylsilyl (meth)acrylate, tri-n-octylsilyl (meth)acrylate, tri-n-dodecylsilyl (meth)acrylate, triphenylsilyl (meth)acrylate, tri-p-methylphenylsilyl (meth)acrylate, tribenzylsilyl (meth)acrylate, dimethylphenylsilyl (meth)acrylate, dimethylcyclohexyl (meth)acrylate, ethyidimethylsilyl (meth)acrylate, n-butydimethylsilyl (meth)acrylate, t-butyidimethylsilyl (meth)acrylate, diisopropyl-n-butylsilyl (meth)acrylate, n-octyidi-n-butylsilyl (meth)acrylate, diisopropylstearylsilyl (meth)acrylate, dicyclohexylphenylsilyl (meth)acrylate, t-butyidiphenylsilyl (meth)acrylate, and lauryldiphenylsilyl (meth)acrylate.

Preferably, triisopropylsilyl (meth)acrylate, tri-n-butylsilyl (meth)acrylate, or triisobutylsilyl (meth)acrylate is used in the preparation of the silyl ester copolymer.

Alternatively, such a water-reactive acid-functional film-forming polymer the acid groups of which are blocked may be a carboxylic acid-functional polymer. For example, it may be a copolymer of acrylic or methacrylic acid with one or more alkyl acrylates or methacrylates, at least some of the acid groups of which have been converted to groups of the formula -COO-M-OH, wherein M is a divalent metal such as copper, zinc, calcium, magnesium or iron, as described in GB 2,311,070.

Another example of such a water-reactive acid-functional film-forming polymer the acid groups of which are blocked is a polymer that is a salt of an amine. Preferably it is a salt of an amine containing at least one aliphatic hydrocarbon group having 8 to 25 carbon atoms and an acid-functional film-forming polymer as described in EP 0 529 693, the acid-functional polymer preferably being an addition copolymer of an olefinically unsaturated carboxylic acid, sulphonic acid, acid sulphate ester, phosphonic acid or acid phosphate ester and at least one olefinically unsaturated co-monomer, the unsaturated carboxylic acid for example being acrylic or methacrylic acid, the unsaturated sulphonic acid for example being 2-acrylamido-2-methylpropane sulphonic acid (AMPS), and the film-forming polymer preferably being an amine sulphonate copolymer containing units of an organocyclic ester as described in WO 99/37723.

As an example of a suitable polymer (B) that is slightly soluble or water-sensitive in water the following compounds can be mentioned: polyvinyl methyl ether, polyvinyl ethyl ether, alkyd resins, modified alkyd resins, polyurethanes, saturated polyester resins, and poly-N-vinyl pyrollidones.

As an example of a suitable polymer (B) that is insoluble in water, the following compounds can be mentioned: modified alkyd resins, epoxy polymers, epoxy esters, epoxy urethanes, polyurethanes, linseed oil, castor oil, soy been oil, and derivatives of such oils.

Other examples of suitable water-insoluble polymers or resins are: vinyl ether polymer, for example a poly(vinyl alkyl ether), such as polyvinyl isobutyl ether, or a copolymer of a vinyl alkyl ether with vinyl acetate or vinyl chloride, an acrylate ester polymer such as a homopolymer or copolymer of one or more alkyl acrylates or methacrylates which preferably contain 1 to 6 carbon atoms in the alkyl group and may contain a co-monomer such as acrylonitrile or styrene, and a vinyl acetate polymer such as polyvinyl acetate or a vinyl acetate vinyl chloride copolymer.

Alternatively, the water-insoluble polymer or resins can be a polyamine, particularly a polyamide having a plasticising effect such as a polyamide of a fatty acid dimer or the polyamide sold under the Trademark “Santiciser”.

If in addition to the film-forming polymer (A), the coating composition comprises one or more polymers (B), these other polymer(s) can form up to 80 percent by weight of the total amount of resins in the coating composition.

Preferably, the composition contains 0-20 wt. % of polymer (B), calculated on the total resins in the coating composition, to obtain a self-polishing coating of high quality.

The total amount of film-forming components present in the coating composition according to the present invention generally is at least 3 wt. %, preferably at least 6 wt. %, more preferably at least 10 wt. %. It is generally at most 60 wt. %, preferably at most 50 wt. %, more preferably at most 45 wt. %.

The coating composition may contain other components conventionally used in the art. As an example, as suitable plasticisers that may be used in the present invention, the following materials may be exemplified: chlorinated paraffins, aromatic phosphate esters such as triisopropylphenyl phosphate, and phthalate esters such as dioctyl phthalate. These materials may be used individually or in combination.

The polymers and other soluble components forming the film-forming binder can be mixed in a common solvent which forms at least part of the coating composition solvent, for example an aromatic hydrocarbon such as xylene, toluene or trimethylbenzene, an alcohol such as n-butanol, an ether alcohol such as butoxyethanol or methoxypropanol, an ester such as butyl acetate or isoamyl acetate, an ether-ester such as ethoxyethyl acetate or methoxypropyl acetate, a ketone such as methyl isobutyl ketone or methyl isoamyl ketone, an aliphatic hydrocarbon such as white spirit, or a mixture of two or more of these solvents. The coating composition can alternatively be water-based.

The antifouling coating composition according to the present invention additionally may comprise sparingly soluble pigments having a solubility in water of 0.5 to 10 parts per million which are not biocides for aquatic organisms. Examples of such pigments include zinc oxide, barium sulphate, calcium sulphate, and dolomite. Mixtures of sparingly soluble biocidal or non-biocidal pigments can be used, for example cuprous oxide, cuprous thiocyanate or copper pyrithione which are highly effective biocidal pigments, can be mixed, optionally with a non-biocidal soluble pigment such as zinc oxide.

In addition to copper-based biocides for aquatic organisms having a low metallic copper content, the antifouling coating composition can contain one or more non-metalliferous biocides for aquatic organisms, i.e. an ingredient having aquatic biocidal properties that is a biocide, but which may or may not be a pigment. Examples of such compounds are tetramethyl thiuram disulphide, methylene bis(thiocyanate), captan, pyridinium triphenylboron, a substituted isothiazolone such as 4,5-dichloro-2-n-octyl4-isothiazolin-3-one, 2-methylthio-4-t.butylamino-6-cyclopropylamino-s-triazine,. N-3,4-dichlorophenyl-N′,N′-dimethyl-urea (“Diuron”), 2-(thio-cyanomethylthio)benzothiazole, 2,4,5,6-tetrachloro-isophthalonitrile, dichlorofluanid, tolylfluanid, 2-(p-chlorophenyl)-3-cyano-4-bromo-5-trifluoromethyl pyrrole, 3-butyl-5-(dibromomethylidene)-2(5H)-furanone 3-(benzo(b)thien-2-yl)-5,6-dihydro-1,4,2-oxathiazine4-oxide, L-menthol, 5-methyl-2-(isopropyl)-cyclohexanol, isoproturon, thiabenzadole, dodecylguanidine monohydrochloride, chlorotoluron, cic4-[3-(p-tert-butylphenyl)-2-methylpropyl]-2,6-dimethylmorpholine, fluometuron, folpet, prometryn, chlorofenapyr, chloromethyl n-octyl disulphide and 2,3,5,6-tetrachloro-4-(methyl-sulphonyl)pyridine. Optionally, the antifouling composition comprises one or more acid-functional biocides, for example, (9E)-4-(6,10-dimethylocta-9,11-dienyl) furan-2-carboxylic acid and p-(sulpho-oxy) cinnamic acid (zosteric acid), or a quaternary ammonium compound such as cetylpyridinium chloride.

Many of these non-metalliferous biocides are solid and all sparingly water-soluble and may help the “self-polishing” action of the coating composition.

The coating composition can additionally contain a pigment which is not reactive with water and may be highly water-insoluble (solubility below 0.5 part per million by weight) such as titanium dioxide or ferric oxide or an organic pigment such as a phthalocyanine or azo pigment. Such highly insoluble pigments are preferably used at less than 60% by weight of the total pigment component of the coating composition, most preferably less than 40%. The coating composition can additionally contain conventional thickeners, particularly thixotropes such as silica, bentonite or polyamide wax and/or stabilisers, for example zeolites or aliphatic or aromatic amines such as dehydroabietylamine.

The coating composition of the present invention is normally applied as a topcoat. As such it can be applied in the normal coating scheme for new build vessel. However, it is also possible to use it as a topcoat in the maintenance and repair of existing vessels and it can also be applied as a topcoat over a coating layer that contains biocidal zinc and/or a rosin material.

Within the framework of the present application, an ocean water aquatic environment is an aquatic environment which has a salinity of approximately 35 practical salinity units (psu, a unit which is based on conductivity measurements), a high salinity aquatic environment is an aquatic environment which has a salinity of between about 15 and 35 psu, a low salinity aquatic environment is an aquatic environment which has a salinity of less than about 15 psu, and a fresh water aquatic environment is an aquatic environment which contains less than about 1000 mg/litre total dissolved solids. Examples of low salinity aquatic environments are river estuaries and semi-enclosed marine environments with high fresh water inputs and restricted exchange with ocean water, such as the Baltic Sea. Examples of fresh water aquatic environments are rivers, lakes and other surface waters.

### EXAMPLES

### Manufacture of compositions A through G

The following materials were mixed in the stated parts by weight in a high speed disperser to prepare antifouling coating compositions:

| | Coating composition | | | | | | |
|---|---|---|---|---|---|---|---|
| Component | A | B | C | D | E | F | G |
| Film forming resin X | 13.8 | 13.8 | 13.8 | 13.8 | 13.8 | 13.8 | 12.2 |
| Plasticiser | 3.6 | 3.6 | 3.6 | 3.6 | 3.6 | 3.6 | 3.2 |
| Thixotropic agent | 0.5 | 0.5 | 0.5 | 0.5 | 0.5 | 0.5 | 0.4 |
| Copper-based | 0.0 | 40.7 | 0.0 | 0.0 | 0.0 | 0.0 | 0.0 |
| biocide A | | | | | | | |
| Copper-based | 40.7 | 0.0 | 40.7 | 40.7 | 40.7 | 40.7 | 50.0 |
| biocide B | | | | | | | |
| Copper-based | 4.5 | 4.5 | 3.4 | 2.2 | 1.1 | 0.0 | 0.0 |
| biocide C | | | | | | | |
| Zinc-based biocide A | 0.0 | 0.0 | 1.1 | 2.2 | 3.3 | 4.4 | 0.0 |
| Colouring pigments | 2.6 | 2.6 | 2.6 | 2.6 | 2.6 | 2.6 | 3 |
| Solvent | 34.3 | 34.3 | 34.3 | 34.3 | 34.3 | 34.3 | 31.2 |

Film-forming resin X is an acrylic acid copolymer substantially in accordance with Production Example 1 of EP0779304-A1 in which the acrylic acid units are blocked by copper bound to naphthenic acid residues.

Copper-based biocide A is a cuprous oxide pigment having a metallic copper content of 2.7% by weight; Copper-based biocide B is a cuprous oxide pigment having a metallic copper content of 0.6% by weight; Copper-based biocide C is a copper pyrithione pigment essentially free of metallic copper. Zinc-based biocide A is a zinc pyrithione pigment.

The solvent was a mixture of xylene, butanol, methyl isobutylketone and butoxypropanol, and the film forming resin A was prepared in solvent prior to mixing with the other coating composition components.

In the above, Coating composition A is accordance to the invention, while coating compositions B through G are comparative.

### Example 1

### The Effect of Metallic Copper Content in the Copper Biocide

Individual 250 ml containers were filled with Coating composition A and Coating composition B, the containers were sealed and placed in a storage oven at 45° C., and the stability of the coating compositions was monitored periodically. After 1 month, Coating composition B exhibited heavy settlement and agglomeration of pigments and the coating composition was no longer suitable for application. In contrast, Coating composition A showed only light settlement of pigments after 6 months. The settled pigment was easily redispersed by stirring with a spatula and the coating composition was still suitable for application.

This result demonstrates that the antifouling coating composition having a metallic copper content below 2% by weight based of the total weight of copper-based biocide has enhanced storage stability.

### Example 2

### The Effect of Biocidal Zinc Compounds on Fresh Water Performance

(a) Fresh water softening

Test coatings were prepared by casting Coating compositions A, C, D, E and F onto separate degreased glass panels (approximately 15 cm×10 cm) using a bar applicator. The coating films were dried under ambient conditions before testing. The hardness of the coating was subsequently determined by the König pendulum damping method described in ISO 1522. Hardness was quantified as the number of pendulum swings to damp from 6° to 3°.

The coatings were then immersed in fresh water at 23° C. for 21 days and the hardness was re-determined immediately on removal from the water and before the coating had dried out.

The results are shown in the table below.

(b) Water uptake

Test coatings were prepared by casting Coating compositions A, C, D, E and F onto separate pre-weighed degreased glass slides (approximately 2 cm×5 cm) using a cube applicator. The coating films were dried under ambient conditions and the dried coated slides were weighed to determine the weight of applied coating composition film. The coated slides were then immersed in fresh water at 23° C. for 7 days. The slides were then re-weighed immediately on removal from the water and before the coating had dried out to determine the water uptake, expressed as a percentage of the original weight of the dried film.

The results are shown in the table below:

| | Coating composition | | | | |
|---|---|---|---|---|---|
| | A | C | D | E | F |
| Konig pendulum hardness | 12 | 12 | 11 | 11 | 11 |
| before fresh water immersion | | | | | |
| (number of swings) | | | | | |
| Konig pendulum hardness after fresh | 15 | 15 | 10 | 9 | 8 |
| water immersion (number of swings) | | | | | |
| Water uptake (% by weight) | 10.4 | 26.8 | 45.0 | 49.7 | 46.1 |

These results show that the presence of the zinc-based biocide has a detrimental effect on the film properties of the coating compositions when immersed in a fresh water environment and leads to excessive water uptake and undue softening of the coating.

### Example 3

### Effect of the Presence of Copper Pyrithione

As a test of antifouling performance, Coating composition A and Coating composition G were applied to plywood boards which had been pre-coating compositioned with a commercial anti-corrosive primer and the boards were immersed in the natural waters of the River Yealm at Newton Ferrers, Devon, England; the River Crouch at Burnham-on-Crouch, Essex, England; and the Johor Strait at Changi, Singapore. The coating composition films were periodically assessed for settlement of fouling organisms and rated on a scale of 0 to 100, where 0 indicates severe settlement and growth of soft and hard bodied animals, algae and slime covering the entire coating composition film, and 100 indicates that the coating composition film is free of fouling. The results are shown in the following table.

| | Coating composition A | | | Coating composition G | | |
|---|---|---|---|---|---|---|
| | Singa- | Devon, | Essex, | | Devon, | Essex, |
| | pore | UK | UK | Singapore | UK | UK |
| Antifouling | 100 | 100 | 100 | 100 | 100 | 100 |
| performance | | | | | | |
| at 1 month | | | | | | |
| Antifouling | 68 | 80 | 68 | 48 | 52 | 64 |
| performance | | | | | | |
| at 3 months | | | | | | |
| Antifouling | 68 | 92 | 68 | 20 | 4 | 20 |
| performance | | | | | | |
| at 10 months | | | | | | |
| Antifouling | 40 | 52 | 40 | 20 | 4 | 20 |
| performance | | | | | | |
| at 14 months | | | | | | |

These results show that the coating compositions of the present invention exhibit superior antifouling performance when copper pyrithione is included in the formulation.

### Example 4

### The Effect of the Biocidal Zinc Compounds on Salt Water Performance

Test coatings were prepared by casting Coating compositions A and F onto separate degreased glass panels (approximately 15 cm×10 cm) using a bar applicator. The coating films were dried under ambient conditions before testing. The hardness of the coating was subsequently determined by the König pendulum damping method described in ISO 1522. Hardness was quantified as the number of pendulum swings to damp from 6° to 3°.

The coatings were then immersed in sea water at 23° C. for 14 days and the hardness was re-determined immediately on removal from the water and before the coating had dried out.

The results are shown in the following table:

Coating
composition

| | B | F |
|---|---|---|
| Konig pendulum hardness before | 12 | 11 |
| sea water immersion (number of | | |
| swings) | | |
| Konig pendulum hardness after sea | 13 | 12 |
| water immersion (number of swings) | | |

These results show that, in contrast to the results of immersion in a fresh water environment, the presence of the zinc-based biocide does not have a detrimental effect on the film properties of the coating compositions when immersed in a sea water environment and does not lead to undue softening of the coating.

### Example 5

### Further Embodiments of the Present Invention

The following materials were mixed in the stated parts by weight in a high speed disperser to prepare antifouling coating compositions:

| | Coating | | |
|---|---|---|---|
| | composition | | |
| Component | H | I | J |
| Film forming resin X | 0.0 | 17.6 | 0.0 |
| Film forming resin Y | 14.8 | 0.0 | 14.5 |
| Plasticiser | 3.6 | 4.6 | 3.6 |
| Thixotropic agent | 0.5 | 0.6 | 0.5 |
| Copper-based | 0.0 | 0.0 | 0.0 |
| biocide A | | | |
| Copper-based | 0.0 | 0.0 | 0.0 |
| biocide B | | | |
| Copper-based | 4.6 | 9.4 | 4.5 |
| biocide C | | | |
| Copper-based | 0.0 | 0.0 | 40.6 |
| biocide D | | | |
| Copper-based | 0.0 | 19.8 | 0.0 |
| biocide E | | | |
| Zinc-based biocide A | 0.0 | 0.0 | 0.0 |
| Zinc Oxide | 39.3 | 0.0 | 0.0 |
| Colouring pigments | 6.3 | 7.9 | 6.2 |
| Solvent | 30.9 | 40.1 | 36.1 |

Film forming resin Y is an acrylic acid copolymer substantially equivalent to Film forming resin X in which the acrylic acid units are blocked by zinc bound to naphthenic acid residues.

Copper-based biocide D is a cuprous oxide pigment having a metallic copper content of below 0.001% by weight. Copper-based biocide E is a copper thiocyanate pigment which is essentially free of metallic copper.

Water Uptake

Water uptake measurements were performed for Coating compositions H, I, and J, as described in Example 2 (b).

| | H | I | J |
|---|---|---|---|
| Water uptake (% by | 0.1 | 4.9 | 16.0 |
| weight) | | | |

These results further illustrate the utility of the coating compositions of the present invention.

1. An antifouling coating composition comprising
20-100% by weight, calculated on the total amount of film-forming components, of a film-forming polymer (A) having an acrylic backbone bearing at least one terminal group of the formula: 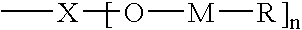
wherein X represents 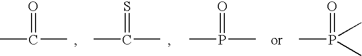
M is a metal of Group Ib, IIa, IIb, IIIa, IIIb, IVa, IVb, Va, VIa, VIb, VIIa, and VIII of the Periodic Table with a valency of 2 or more and a degree of ionisation less than that of the alkali metals metal; n is an integer of 1 to 2; R represents an organic residue selected from 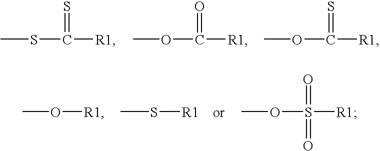
and R1 is
a monovalent organic residue, and
80-0% by weight, calculated on the total amount of film-forming components, of polymer (B) is selected from polymers which are free of-X-[O-M-R]ₙ terminal groups but which are reactive in water, slightly water-soluble, water-sensitive, or insoluble in water.
a copper-based biocide for aquatic organisms
wherein the antifouling coating composition is substantially free of any biocidal zinc compounds and substantially free of rosin, and the copper-based biocide has a metallic copper content below 2% by weight, based on the total weight of the copper-based biocide.

2. The antifouling coating composition according to claim 1, wherein M is Cu, Zn, or Te.

3. The antifouling coating composition according to claim 1, wherein the film-forming polymer (A) is an acrylic polymer in which X represents 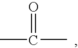
M is copper and R represents 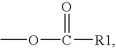
wherein R1 is a monovalent organic residue.

4. The antifouling coating composition according to 1, wherein the copper-based biocide for aquatic organisms comprises cuprous oxide having a metallic copper content below 2% by weight, based on the total weight of the cuprous oxide.

5. The antifouling coating composition according to claim 4, wherein the cuprous oxide has a metallic copper content below 1% by weight, based on the total weight of the cuprous oxide.

6. The antifouling coating composition according to wherein the copper-based biocide for aquatic organisms comprises copper pyrithione.

7. The antifouling coating composition according to claim 6, wherein the copper-based biocide for aquatic organisms comprises a combination of cuprous oxide having a metallic copper content below 2% by weight, based on the total weight of the cuprous oxide and copper pyrithione.

8. The antifouling coating composition according to claim 1, wherein the film-forming polymer (A) is an acrylic polymer in which X represents 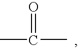
M is copper and R is the residue of an organic monobasic carboxylic acid which has a boiling point greater than 115° C. and an acid value between 50 and 950 mgKOH/gramme, wherein the copper-based biocide for aquatic organisms comprises a combination of cuprous oxide having a metallic copper content below 2% by weight, based on the total weight of the cuprous oxide and copper pyrithione.

9. A process for protecting a man-made structure immersed in a fouling aquatic environment wherein the structure is coated with an antifouling coating composition according to claim 1.

10. The process of claim 9, wherein the aquatic environment is a low salinity aquatic environment.

11. A man-made structure immersed in a fouling aquatic environment coated with a coating composition according to claim 1.

12. The man-made structure of claim 11 which is immersed in a low-salinity aquatic environment.

13. The man-made structure of claim 11 wherein the structure is immersed in a low-salinity aquatic environment for part of its life and in a saline aquatic environment for part of its life.
